(19) United States
(12) Patent Application Publication
(10) Pub. No.: US 2026/0187573 A1
(43) Pub. Date: Jul. 2, 2026

(54) MAINTENANCE WORK ANALYSIS SYSTEM AND MAINTENANCE WORK ANALYSIS METHOD FOR SEMICONDUCTOR MANUFACTURING EQUIPMENT

(71) Applicant: HITACHI HIGH-TECH CORPORATION, Minato-ku, Tokyo (JP)

(72) Inventors: Takashi NUMATA, Tokyo (JP); Nachito IKEDA, Tokyo (JP); Yuya OGI, Tokyo (JP); Keiichi MITANI, Tokyo (JP); Ryota KAWAMATA, Tokyo (JP); Kohei SATO, Tokyo (JP)

(21) Appl. No.: 18/845,184

(22) PCT Filed: Aug. 8, 2023
(86) PCT No.: PCT/JP2023/028914

§ 371 Date: Sep. 9, 2024

(51) Int. Cl. G06Q 10/0639; G06T 7/246; G06V 40/10; G06V 40/20

(52) U.S. Cl. CPC G06Q 10/06398; G06T 7/246; G06V 40/10; G06V 40/20; G06T 2207/30164; G06T 2207/30196; G06T 2207/30241

(57) ABSTRACT

To provide a technology capable of providing maintenance workers with more useful information.

One of the maintenance work analysis system according to the present invention analyzes work actions in maintenance work for the semiconductor manufacturing equipment. The maintenance work analysis system includes an information acquisition portion, an information analysis portion, and an information visualization portion. The information acquisition portion acquires work information including movement information indicating the movement of the worker performing the maintenance work. The information analysis portion analyzes the worker's work action based on the work information, and the information visualization portion outputs a difference between reference maintenance work and the maintenance work performed by the worker.

### TECHNICAL FIELD

The present invention relates to a maintenance work analysis system and a maintenance work analysis method for semiconductor manufacturing equipment.

### BACKGROUND ART

The semiconductor manufacturing equipment is more complexly configured than general manufacturing equipment. The semiconductor manufacturing equipment greatly influences the yield of semiconductor devices manufactured through the use of the equipment. Workers require a lot of knowledge and skills in performing maintenance work such as inspecting and maintaining the semiconductor manufacturing equipment. Many techniques have been developed to reduce the burden on workers performing maintenance work on semiconductor manufacturing equipment.

Patent Literature 1 aims to provide a technology capable of shortening device maintenance time and discloses a user interface and maintenance guidance method as follows.

“The user interface 52 includes an operation screen and an operation portion. The operation screen displays predetermined information on the device and is used for predetermined operations. The operation portion is used to manipulate the operation screen. The user interface 52 includes a maintenance mode to maintain the device on the operation screen. In the maintenance mode, the operation screen displays a maintenance screen 101 corresponding to predetermined maintenance items out of those stored as maintenance operations in a storage portion 53. For each procedure, the maintenance screen 101 displays the maintenance details of the maintenance item based on the information in the storage portion 53. The screen 101 for each procedure displays an explanation 105 of the procedure and image 106 representing the maintenance location.”

Patent literature 2 aims to visually provide workers with the information they need and they need to know and discloses a support information display method, a maintenance support method for a substrate processing apparatus, a support information display control device, a substrate processing system, and a program as follows. “While maintaining the substrate processing apparatus, a worker wears a head-mounted display (HMD) 30 that displays maintenance-related support information in real-time. To do this, the display control device 40 of the substrate processing system 100A acquires an image that is generated from the camera included in the HMD 30 and represents a predetermined location to be maintained in the substrate processing apparatus. The display control device 40 estimates support information related to the predetermined location included in the acquired image from information stored in the database. The display control device 40 images the estimated support information and displays a generated image on the HMD 30, thereby allowing the worker to visually recognize the support information.”

### CITATION LIST

### Patent Literature

Patent Literature 1: Japanese Unexamined Patent Application Publication No. 2019-016759

Patent Literature 2: Japanese Unexamined Patent Application Publication No. 2014-164482

### SUMMARY OF INVENTION

### Technical Problem

Maintenance work for the semiconductor manufacturing equipment is sometimes found to be unsuccessful during the semiconductor manufacturing process after the maintenance work due to the occurrence of a large amount of a particle. Maintenance work may need to be redone. A possible reason may be that it is impossible to completely predefine all finger movements of workers engaged in the maintenance work.

Specifically, work movements such as line of sight, positions or movements of fingers, and working posture during the maintenance work depend on the judgment and experience of each worker. The maintenance work is estimated to be successful or not due to large individual differences such as worker skill levels.

However, there has been no sufficient evidence about the correlation between individual workers' differences and successful or unsuccessful maintenance work regarding the presence or absence of leakage, the amount of the particle, process performance, or yield after maintenance work. The cause of an unsuccessful maintenance work is unclear. There has been insufficient feedback to workers and deficient examination of tasks and parts likely to cause unsuccessful maintenance.

Patent literatures 1 and 2 do not sufficiently consider these points.

It is an object of the present invention to provide a technology capable of providing maintenance workers with more useful information.

### Solution to Problem

To solve the above-described issues, one of the representative maintenance work analysis system according to the present invention analyzes work actions in maintenance work for the semiconductor manufacturing equipment. The maintenance work analysis system includes an information acquisition portion, an information analysis portion, and an information visualization portion. The information acquisition portion acquires work information including movement information indicating the movement of the worker performing the maintenance work. The information analysis portion analyzes the worker's work action based on the work information. The information visualization portion outputs a difference between reference maintenance work and the maintenance work performed by the worker.

### Advantageous Effects of Invention

The present invention makes it possible to supply more useful information to maintenance workers.

The description of the embodiment below will clarify issues, configurations, and effects other than those described above.

### BRIEF DESCRIPTION OF DRAWINGS

FIG. 1 is a diagram illustrating the use of the maintenance work analysis system according to the embodiment;

FIG. 2 is a diagram illustrating an example of the configuration of the maintenance work analysis system;

FIG. 3 is a diagram illustrating an example of the configuration of a measurement system;

FIGS. 4A-4C are diagrams illustrating processing that associates maintenance work with worker movements;

FIGS. 5A-5C are diagrams illustrating the information used for the analysis of an information analysis portion;

FIGS. 6A and 6B are diagrams illustrating an example of the work action analysis performed in the information analysis portion;

FIG. 7 is a diagram illustrating an example of visualization results displayed in an output portion; and

FIG. 8 is a flowchart illustrating analysis processing performed in the maintenance work analysis system.

### DESCRIPTION OF EMBODIMENTS

The embodiment of the present invention will be described in further detail by reference to the accompanying drawings. The present invention is not limited to the embodiment. The same reference numerals represent the same parts in the description of the drawings.

### Example Applications of Maintenance Work Analysis System

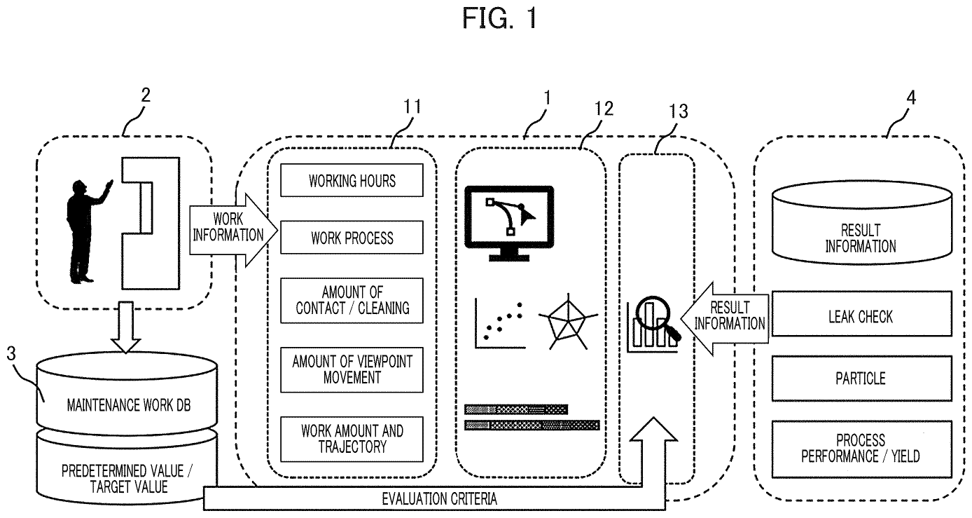

FIG. 1 is a diagram illustrating the use of the maintenance work analysis system according to the embodiment. FIG. 1 illustrates the relationship among a maintenance work analysis system 1, a measurement system 2, a maintenance work DB (database) 3, and an evaluation system 4.

The maintenance work analysis system 1 analyzes work actions in maintenance work for the semiconductor manufacturing equipment. The maintenance work analysis system 1 includes an evaluation index acquisition function 11, a visualization interface function 12, and an analysis function 13. The semiconductor manufacturing equipment processes and inspects semiconductor devices, and includes process equipment such as plasma processing equipment, testing equipment, and assembly equipment, for example.

The evaluation index acquisition function 11 acquires evaluation indexes to be analyzed for maintenance work. For example, the evaluation indexes include working hours related to maintenance work, work processes performed as maintenance work, the contact amount as the amount (time or range, for example) of worker's contact with a certain part (location) of the semiconductor manufacturing equipment (such as the amount of cleaning (duration of cleaning or range of cleaning, for example) when cleaning work is included), the amount of movement of the worker's viewpoint, and the work amount and trajectory as the displacement of worker's body parts (such as hands, arms, or elbows). The evaluation index acquisition function 11 is acquired from the measurement system 2 which measures worker's movements during the maintenance work.

The visualization interface function 12 presents the analysis and evaluation of the maintenance work to the worker and the user of the maintenance work analysis system 1. The following description mainly focuses on visualization and illustrates outputs stimulating the visual sense. However, the present disclosure is not limited thereto. The method of output to the worker and user may include audio, for example, that appeals to senses other than the visual sense.

The analysis function 13 analyzes an evaluation index. The method of analysis compares evaluation indexes extracted during maintenance work with data as a work reference. The comparison can use various methods. For example, the maintenance work DB 3 stores information indicating the movements of workers during maintenance work. Predetermined values for data or data as target values are extracted as data indicating evaluation criteria from the maintenance work DB 3. The evaluation system 4 includes a semiconductor measurement equipment and a semiconductor instrumentation equipment. The evaluation system 4 acquires data indicating the states of the semiconductor manufacturing equipment during operation and semiconductor device measurement data after operation of the semiconductor manufacturing equipment. Data acquired from the evaluation system 4 may indicate an inappropriate state, predicting that the maintenance work is unsuccessful. In this case, the evaluation index analysis also makes it possible to determine which processes and parts locations of the semiconductor manufacturing equipment affected the results of maintenance work.

### Configuration of Maintenance Work Analysis System

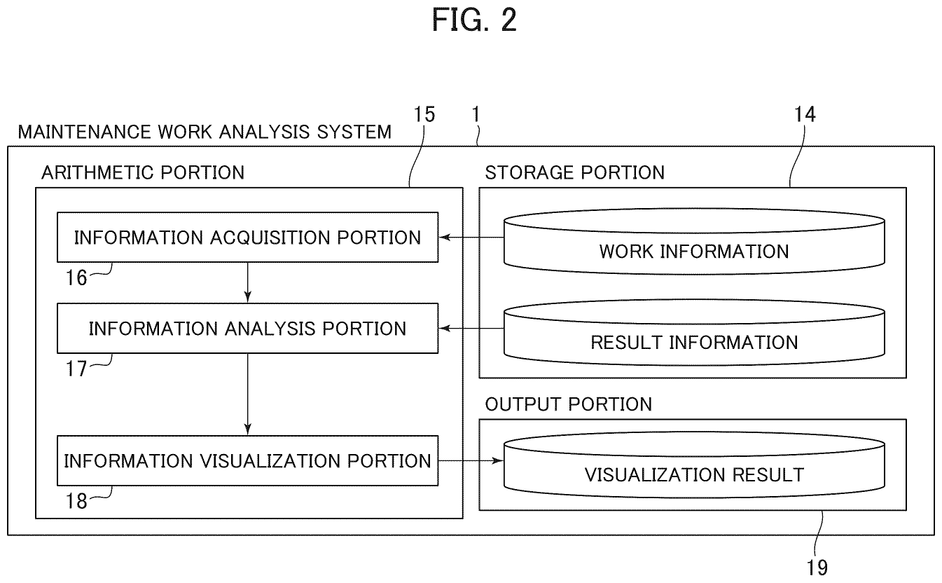

FIG. 2 is a diagram illustrating an example of the configuration of the maintenance work analysis system 1. The maintenance work analysis system 1 includes storage portion 14, the arithmetic portion 15, and the output portion 19.

The storage portion 14 stores work information and result information. The work information includes movement information indicating the movement of a worker who performs maintenance work. The result information includes information regarding the success or failure of the worker's maintenance work.

The work information is acquired in the measurement system 2. The measurement system 2 acquires information indicating the worker's movements from various sensors such as cameras installed in the environment where maintenance work is performed and from positioning sensors attached to the worker's body. The measurement system 2 then transmits the acquired information to the storage portion 14. The measurement system 2 will be described later.

The result information is acquired in the evaluation system 4. The evaluation system 4 includes the semiconductor measurement equipment and the semiconductor instrumentation equipment. The result information includes data obtained by operating the semiconductor manufacturing equipment and measurement data regarding semiconductors manufactured by the semiconductor manufacturing equipment. For example, the result information includes results of leak check applied to the semiconductor manufacturing equipment, measurement of ultimate vacuum, results of the particle detection based on measuring gas compositions in the semiconductor manufacturing equipment, results of detecting the particles attached to semiconductors, evaluation results of semiconductor profile shapes after manufacturing treatment, process performance as evaluation result of electrical characteristics, and semiconductor yield after manufacturing treatment. The result information can also include temperature, gas flow rate, pressure, frequency, and RF power, for example, in the processing equipment during the operation of the semiconductor manufacturing equipment.

The arithmetic portion 15 includes the information acquisition portion 16, the information analysis portion 17 and the information visualization portion 18. The information acquisition portion 16 acquires work information from the storage portion 14. The information analysis portion 17 analyzes the worker's work actions from the work information. The information visualization portion 18 outputs the difference between the reference maintenance work and the maintenance work performed by the worker. In addition, the information visualization portion 18 performs visualization such as representing the results of the analysis performed by the information analysis portion 17 in numeric values, graphs, and video, for example.

The output portion 19 supplies the visualization information output from the information visualization portion 18 to the worker of the maintenance work and the user of the maintenance work analysis system 1. The output portion 19 is applicable to a display, a mobile terminal such as a smartphone, or an HMD (Head Mounted Display). The output portion 19 used as HMD can display AR contents superimposed on the actual semiconductor manufacturing equipment.

The maintenance work analysis system 1 may be configured as hardware including computers and servers or as a cloud service, for example.

### Configuration of Measurement System

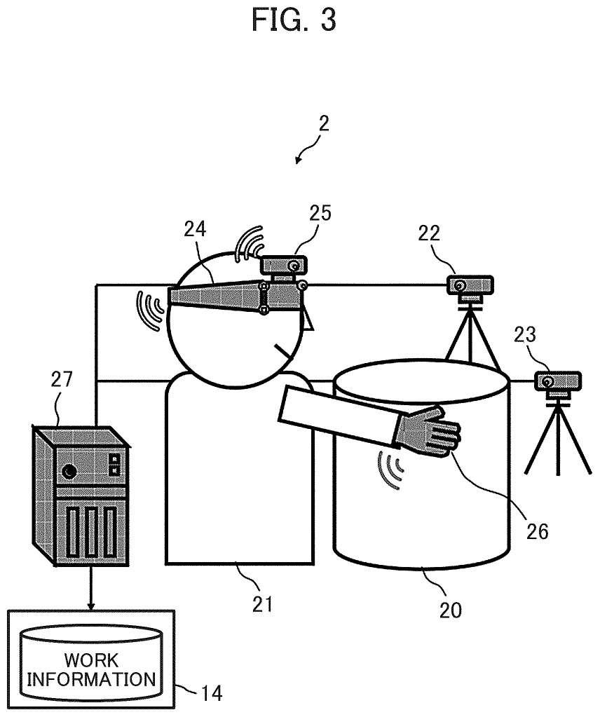

FIG. 3 is a diagram illustrating an example of the configuration of the measurement system 2. FIG. 3 illustrates an example of a system that measures the movements of a worker performing maintenance work for the semiconductor manufacturing equipment.

A chamber 20 is one of components configuring the semiconductor manufacturing equipment. The worker 21 is working while extending the worker's arm into the chamber 20 and looking into the inside of the chamber 20. Imaging devices 22 and 23 are installed in a work environment where maintenance work is performed. The imaging device 22 captures images so that the entire image of the worker 21 falls into the angle of view. The imaging device 23 captures images so that the chamber 20 and hands of the worker 21 fall into the field of view. The imaging devices 22 and 23 can use a 3D camera (RGB-D sensor).

An HMD 25 is attached to the head of the worker 21. The HMD 25 includes an RGB-D sensor, a head position/orientation sensor (such as a tracking sensor), and a viewpoint sensor to detect the head and the line of sight of the worker 21. The imaging device 25 attached to the head of the worker 21 can detect the line of sight of the worker 21.

The hand of the worker 21 is equipped with a glove-shaped sensor 26 that estimates the movement of the hand based on the pressure distribution on the palm, for example. A measurement PC 27 collects information from the imaging devices 22, 23, 25, the HMD 24, and the sensor 26.

The above-described sensors collect movement information indicating the movement of the worker 21. For example, the imaging devices 22 and 25 acquire information indicating the line of sight of the worker 21. The imaging device 22 and the HMD 24 acquire information indicating the head position and head movement (variation amount) of the worker 21. The imaging device 23 and the sensor 26 acquire information indicating the finger position and finger movement (variation amount) of the worker 21. The imaging device 22 acquires information indicating the working posture of the worker 21. The measurement PC 27 acquires the motion information and stores it as work information in the storage portion 14. Movement information acquired from skilled workers (hereinafter also referred to as “experts”) can be used as predetermined values or target values for work analysis and is also saved in the maintenance work DB 3. For example, expert work adopted as a predetermined value or target value signifies maintenance work (successful work) that causes no leakage or remaining the particle, provides a yield exceeding a required value, and consumes an extremely short amount of time.

The measurement system 2 is not limited to the above description. For example, the motion information can be acquired by using at least one 3D camera to capture the worker 21 and the semiconductor manufacturing equipment. It may be favorable to use sensors other than imaging devices and tracking sensors.

### Maintenance Work Analysis Processing

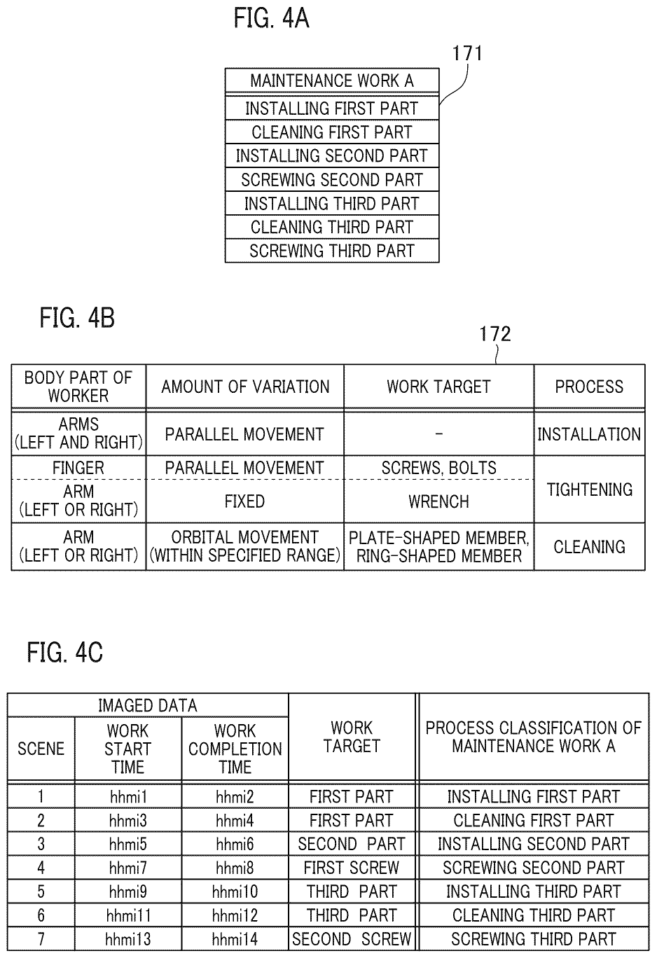

The description below explains the processing performed in the maintenance work analysis system by reference to FIGS. 4 to 8.

### Classification of Maintenance Work Processes

FIGS. 4A-4C are diagrams illustrating processing that associates maintenance work with worker movements. FIG. 4A is a diagram illustrating an example of classification information 171 that classifies maintenance work based on processes. As illustrated in the drawing, maintenance work A includes processes such as installing the first part, cleaning the first part, installing the second part, screwing the second part, installing the third part, cleaning the third part, and screwing the third part. The information analysis portion 17 previously includes classification information 171 indicating the relationship between the maintenance work and the processes included in the maintenance work.

FIG. 4B is a diagram illustrating an example of association information 172 that associates the movement of a worker with a work target to be maintained. The information analysis portion 17 acquires the association information 172 illustrated in FIG. 4B in addition to the classification information 171 illustrated in FIG. 4A to perform classification. Suppose the worker's right and left arms parallel move to a certain object (no work target limited). This process is classified as installing that object in the association information. Suppose the fingers parallel move, one arm is fixed, and the work target includes tools such as screws and bolts or wrenches, for example. Then, the process is classified as fastening. Suppose one of the worker's arms is moving around within a predetermined range, and the work target includes a plate-shaped member or a ring-shaped member. Then, the process is classified as cleaning.

FIG. 4C is a diagram illustrating an example of the association between imaged data and maintenance work processes. Imaged data can be acquired from any of the imaging devices 22, 23, 25, and HMD 24. Imaged data may be a combination of data acquired from these imaging means.

The information analysis portion 17 uses motion information for analysis and associates the imaged data with the maintenance work target. For example, suppose the viewpoint and finger are positioned within a range including the first part for a predetermined period. Then, the first part is determined as a work target. In terms of the imaged data, scene 1 (work start time hhmi1 to work completion time hhmi2) and scene 2 (work start time hhmi3 to work completion time hhmi4) are determined to as operations on the first part.

Scene 1 and scene 2 indicate the first part as a work target but cannot determine a difference in work. The information analysis portion 17 references the association information 172 and thereby extracts a difference between scene 1 and scene 2 in terms of the motion information. The information analysis portion 17 extracts a difference in the variation amount of the worker's arm and can classify the processes such that scene 1 is the installation process on the first part and scene 2 is the cleaning process on the first part.

Scene 3 corresponds to the second part as the work target. Scene 4 corresponds to the first screw as the work target. The information analysis portion 17 references association information 172 and the order of processes, for example, and can classify the processes such that scene 3 is the installation process of the second part and scene 4 is the screwing process of the second part.

Scene 5 and scene 6 correspond to the third part as the work target. Scene 7 corresponds to the second screw as the work target. The information analysis portion 17 references information such as the association information 172 and the order of processes and can classify the processes such that scene 5 is the installation process of the third part, scene 6 is the cleaning process of the third part, and scene 7 is the screwing process of the third part.

As above, the imaged data can be analyzed through the use of motion information, making it possible to associate the maintenance work process with the work target location. The association is available by using a classifier or allowing the user of the maintenance work analysis system 1 to generate annotation data.

The information analysis portion 17 analyzes the work action by using at least one piece of motion information as an evaluation index. In addition, the information analysis portion 17 analyzes the work action by presenting an evaluation index specific to the work target. The work action signifies movements or operations related to maintenance work (or processes included in the maintenance work). The movement information, when used as an evaluation index, makes it possible to use so-called primary movement information such as positions and variation amounts of the viewpoint or arm. The association information 172 in FIG. 4B makes it possible to use evaluation indexes specific to work targets, such as the speed to install an object, the speed to fasten a screw, and the area and time to clean a region. These evaluation indexes can be derived from the primary information, for example. For example, it may be determined that a favorable cleaning work is to wipe in one direction rather than back and forth. When the cleaning direction is used as an evaluation index, the movement trajectory of the hand can be used to calculate and evaluate the angular velocity distribution, average velocity, velocity ratio, and distribution distortion, for example, thus deriving the cleaning direction. Classification of the imaged data and processes also makes it possible to use the work time required for a process as an evaluation index.

The evaluation indexes may apply to the timing and number of times to change gloves, change the cloth for cleaning, and apply a cleaning liquid, for example, in addition to the works that allow workers to directly touch the semiconductor manufacturing equipment. These evaluation indexes can be extracted by applying image processing such as object detection to imaged data acquired by an imaging device, for example.

The above description illustrates an example of processing to associate the maintenance work with worker actions, but the present disclosure is not limited thereto.

### Analysis of Maintenance Work and Successful or Unsuccessful Process

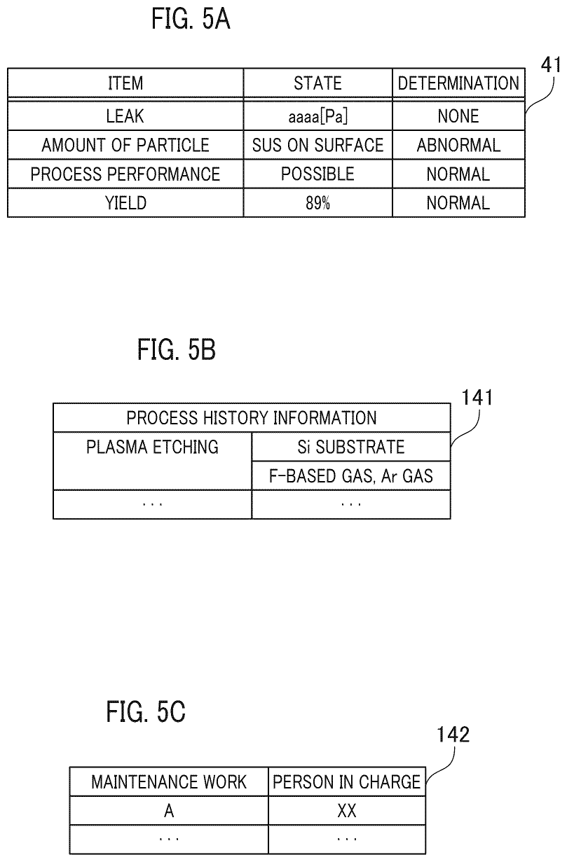

FIGS. 5A-5C are diagrams illustrating the information used for the analysis of an information analysis portion. FIG. 5A is a diagram illustrating an example of measurement data acquired in the evaluation system 4. Measurement data 41 is the result of measurement during the process performed in the semiconductor manufacturing equipment and the result of an evaluation of the semiconductor device after the process. The measurement data 41 provides result information including information regarding the worker's successful or unsuccessful maintenance work and is stored in the storage portion 14 of the maintenance work analysis system 1. The measurement data 41 includes at least one of the presence or absence of leakage, the amount of the particle, and the process performance or yield after maintenance as information regarding the successful or unsuccessful maintenance work. The description below explains the details.

The item “leak” indicates the presence or absence of a leak based on the results of a leak check and measurement of the ultimate vacuum performed during the process. The item “amount of the particle” is determined from the results of measuring the gas composition in the semiconductor manufacturing equipment and detecting the particle adhering to semiconductors. The item “process performance” is determined from the results of evaluating the semiconductor profile shape or electrical characteristics, for example. The item “yield” is determined from the yield of the semiconductor after the process.

The item “leak” indicates that the ultimate vacuum aaaa [Pa] is a normal value and the leak check detects no abnormality. Therefore, it is determined that there is no leak. The item “amount of the particle” is determined to be abnormal because SUS is detected on the surface of the semiconductor. The item “process performance” is determined to be normal because the evaluation result is acceptable. The item “yield rate” is calculated to be 89% and is determined to be normal.

FIG. 5B is a diagram illustrating an example of history information 141 on processes performed in the semiconductor manufacturing equipment. FIG. 5C is a diagram illustrating an example of preliminary information 142 indicating the contents of maintenance work performed in the conductor manufacturing apparatus. The history information 141 and the preliminary information 142 are stored as part of work information in the storage portion 14. The history information 141 and the preliminary information 142 apply to the common semiconductor manufacturing equipment and are also associated with the measurement data 41 (result information).

The process history information 141 includes the materials used and manufacturing methods. Si substrate, F-based gas, and Ar gas are shown as the materials used. Plasma etching is shown as the manufacturing method. When multiple processes were performed, the history information 141 may also include the materials and manufacturing methods of the other processes. The materials may not be limited to the substrate and gas type. The manufacturing method may include major manufacturing conditions.

The preliminary information 142 includes information indicating the maintenance work performed on the semiconductor manufacturing equipment and the worker in charge of the work before the process is performed. Maintenance work A is performed by worker XX. When multiple maintenance works are performed, it is also possible to include information indicating other maintenance works.

### Analysis of Work Action

The information analysis portion 17 combines the worker's work information and the result information to analyze the factors behind the result information. The information analysis portion 17 uses the historical information and the preliminary information to analyze work actions. The information analysis portion 17 determines, based on the measurement data 41, that SUS is detected on the board and an abnormality occurs regarding the item “amount of the particle.” The history information 141 included in the work information reveals that no process using SUS is performed. The preliminary information 142 reveals that worker XX performed maintenance work A on the semiconductor manufacturing equipment. The information analysis portion 17 analyzes the work actions of worker XX performing maintenance work A based on the determination that maintenance work A, not the process, is the factor of detecting the particle.

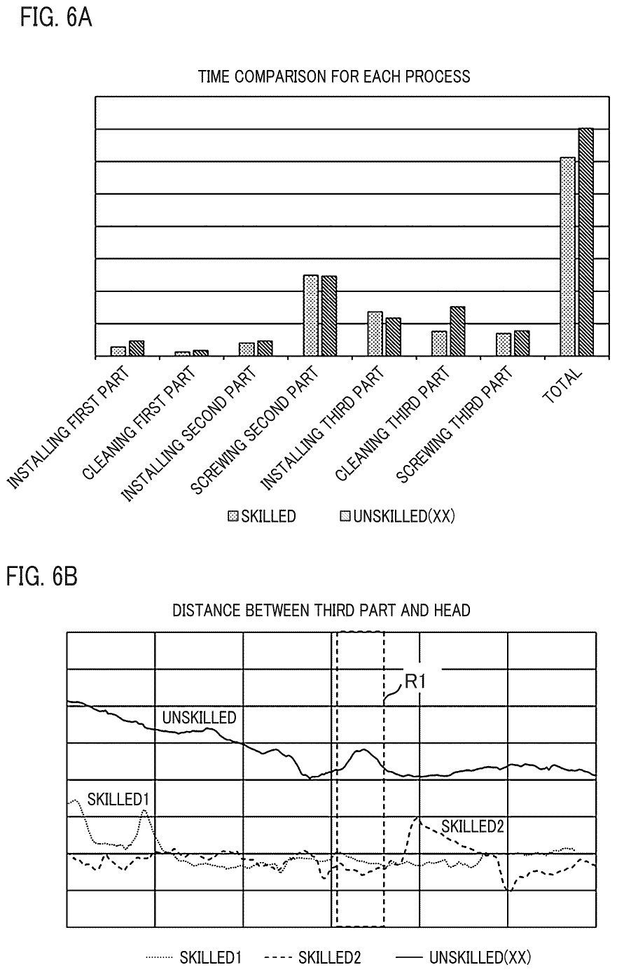

FIGS. 6A and 6B are diagrams illustrating an example of the work action analysis performed in the information analysis portion 17. FIG. 6A is a diagram illustrating the working time of each process included in maintenance work A. The horizontal axis separately shows the processes included in maintenance work A. The vertical axis shows the working time. The information analysis portion 17 compares the work action of worker XX with the movement information that is acquired from the maintenance work DB 3 and represents the expert's maintenance work A. In the drawing, the dotted bar graph shows the expert's work time and the hatched bar graph shows the work time of worker XX.

The information analysis portion analyzes work actions by focusing on a specific work that belongs to work targets and affects the success or failure of maintenance work. The specific work is cleaning work. The information analysis portion analyzes the trajectory and speed of the worker's body parts during cleaning work. The information analysis portion 17 compares the expert's work with the work of worker XX. Based on predetermined criteria, for example, the information analysis portion 17 extracts a process that causes the deviation from the expert's working time to be greater than or equal to a predetermined value. A large difference is found in the working time of the cleaning process on the third part. The information analysis portion 17 focuses on the third part of the chamber as the work target.

FIG. 6B is a diagram illustrating the distance between the third component and the worker's head. The vertical axis indicates the distance between the third part and the worker's head, and the horizontal axis indicates time. The solid line corresponds to worker XX, the dotted line corresponds to the first expert, and the broken line corresponds to the second expert. The solid line is separated from the dotted and broken lines, indicating that the trajectory of the head of worker XX is measured at a distance away from the third part. Region R1 shows that the experts cause no variations but the head position of worker XX causes variations. The diagram shows that the head moves at a high speed.

The information analysis portion 17 analyzes that the head was located away from the third part during the cleaning process on the third part and caused one of the factors to detect the particle. The results of the analysis performed in the information analysis portion 17 are transmitted to the information visualization portion 18.

As above, the information analysis portion 17 analyzes the maintenance work of worker XX by using the work information (such as the measurement data 41, the history information 141, the preliminary information 142, and the expert work movement information). The analysis method is not limited to that described above. Other tasks may be extracted as specific tasks. Analysis may be performed on parts of the body other than the head.

### Visualization of Analysis Results

When the result information indicates a failure, the information visualization portion 18 outputs information about the work and parts that may cause factors. Based on the results of the analysis from the information analysis portion 17, the information visualization portion 18 visualizes the cleaning process on the third part as a work comparable to a possible factor and the third part as a part comparable to a possible factor so that the operator and the user can be notified. The information visualization portion 18 transmits a visualized result or visualization result to the output portion 19.

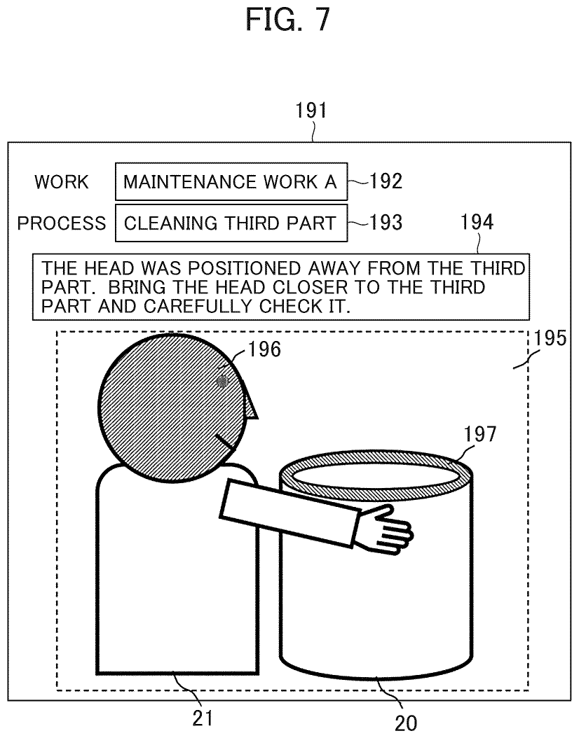

FIG. 7 is a diagram illustrating an example of visualization results displayed in the output portion 19. A display portion 191 of the output portion 19 includes information on work and parts. A work field 192 indicates the work process as the result information factor. A process field 193 indicates the part as the factor. The work filed 192 illustrates maintenance work A. The process filed 193 illustrates the cleaning process on the third component.

A feedback field 194 explains the analyzed factors concerning the worker and provides advice to improve the work. The feedback field 194 includes the text describing that the head was located away from the third part and the worker needs to be alerted to increase the possibility of noticing the particle while working.

A visualization area 195 includes a display that supplies visual feedback to the worker or user. In this example, the visualization area 195 illustrates a scene from the imaged data including the worker 21 to perform the cleaning process and the chamber 20. A head 196 of the worker 21 and a third part 197 are highlighted.

There has been described the visualization method but the present disclosure is not limited thereto. For example, it may be favorable to score differences between the expert's work and the worker's work and evaluate the quality of the worker's work.

The display portion 191 may be included in an HMD. It is also possible to accumulate the analysis results of a certain worker and extract work trends and, during the work in real-time, notify body locations and parts causing possible failure.

### Processing Procedures

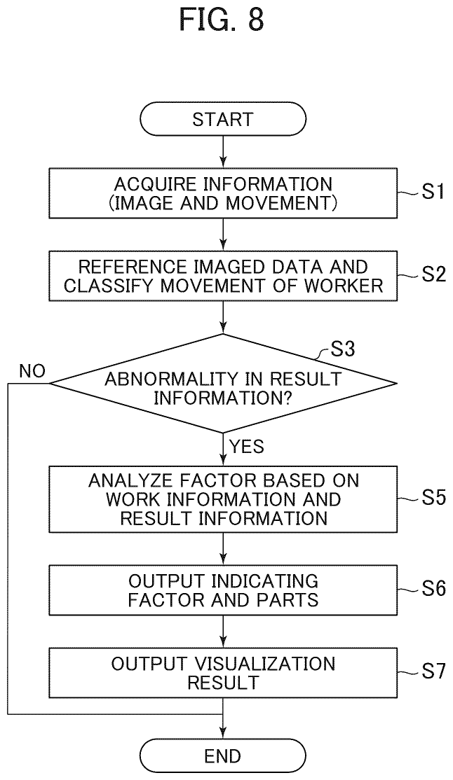

FIG. 8 is a flowchart illustrating analysis processing performed in the maintenance work analysis system 1.

The information acquisition portion 16 acquires work information on maintenance work performed on the semiconductor manufacturing equipment (step S1). The work information includes worker movement information and imaged data acquired by the imaging device.

The information analysis portion 17 then references the imaged data and classifies the worker's movements on a process basis (step S2). The information analysis portion 17 also references the classification information 171 and the association information 172. The classification information 171 categorizes maintenance work on a process basis. The association information 172 identifies a process based on worker movement and work targets.

The information analysis portion 17 then detects whether an abnormality is found in the result information on the process performed in the semiconductor manufacturing equipment (step S3). If there is an abnormality (Yes at step S3), the information analysis portion 17 combines the worker's work information with the result information to analyze the factors behind the work result (step S5). The factor analysis compares the worker's work information with the expert work information. The analysis focuses on a specific work that is included in the maintenance work and is determined to be highly related to the factors. The results of the analysis performed in the information analysis portion 17 are transmitted to the information visualization portion 18.

The information visualization portion 18 references the analysis results and outputs information indicating the factor and work (step S6). The information visualization portion 18 transmits the visualized results to the output portion 19 so that the worker and the user can be notified. The output portion 19 outputs the visualization result (step S7).

The result information may not indicate any abnormality (No at step S3). In this case, the information visualization portion 18 may perform an analysis based on a predetermined evaluation index and then notify the worker that there is no abnormality. It is also possible to save the work information as expert work in the storage portion 14 and use it for analysis.

### Operations and Working Effects

According to the present disclosure, it is possible to provide feedback on the difference between reference maintenance work (expert work) and maintenance work of each worker and quantitatively and objectively extract operations and parts likely to cause unsuccessful maintenance work, making it possible to locate the cause of unsuccessful maintenance work. The factor analysis is performed on the work actions of the worker's body parts such as line of sight, fingers, and posture. Even inexperienced workers can achieve work quality comparable to that of experts.

The present disclosure makes it possible to provide maintenance workers with more useful information.

While there has been described the embodiment of the present invention, it is to be distinctly understood that the invention is not limited to the above-described embodiment and may be variously modified without departing from the scope of the invention.

The description below explains possible aspects of the present invention, but the invention is not limited thereto.

### Aspect 1

A maintenance work analysis system to analyze work actions in maintenance work on a semiconductor manufacturing equipment includes an information acquisition portion that acquires work information including movement information indicating the movement of a worker performing the maintenance work, an information analysis portion that analyzes work actions of the worker from the work information, and an information visualization portion that outputs a difference between reference maintenance work and maintenance work performed by the worker.

### Aspect 2

The maintenance work analysis system according to aspect 1, the information acquisition portion acquires result information including information regarding the success or failure of the maintenance work conducted by the worker, and the information analysis portion combines the work information of the worker with the result information and analyzes a factor of the result information, and when the result information indicates a failure, the information visualization portion outputs information regarding work and parts as a possible factor.

### Aspect 3

The maintenance work analysis system according to aspect 1 or 2, the work information includes preliminary information that indicates history information and maintenance work concerning a process performed in the semiconductor manufacturing equipment, and the information analysis portion analyzes the work action by using the history information and the preliminary information.

### Aspect 4

The maintenance work analysis system according to any one of aspects 1 to 3, the work information includes information indicating at least one of line of sight, head position/movement, finger position/movement, and work posture as the movement information, and the information analysis portion analyzes the work action by using at least one piece of the motion information as an evaluation index.

### Aspect 5

The maintenance work analysis system according to any one of aspects 1 to 4, information concerning the success or failure of the maintenance work includes at least one of the presence or absence of leakage, amount of the particle, and process performance or yield after maintenance.

### Aspect 6

The maintenance work analysis system according to any one of aspects 1 to 5, the information analysis portion acquires association information that associates the movement of a worker with a work target to be maintained, and analyzes the work action by presenting an evaluation index specific to the work target.

### Aspect 7

The maintenance work analysis system according to any one of aspects 1 to 6, the information analysis portion analyzes the work action by focusing on a specific work that is included in the work target and is particularly related to the success or failure of the maintenance work.

### Aspect 8

The maintenance work analysis system according to any one of aspects 1 to 7, the specific work is cleaning work, and the maintenance work analysis system analyzes the trajectory and speed of body parts of the worker during the cleaning work.

### Aspect 9

A maintenance work analysis method of analyzing work actions in maintenance work on semiconductor manufacturing equipment, includes an information acquisition step to acquire work information including movement information indicating the movement of a worker conducting the maintenance work, and an information analysis step to analyze work actions of the worker from the work information, and an information visualization step to output a difference between reference maintenance work and maintenance work conducted by the worker.

### LIST OF REFERENCE SIGNS

1: maintenance work analysis system, 2: measurement system, 3: maintenance work DB, 4: evaluation system, 11: acquisition function, 12: visualization interface function, 13: analysis function, 14: storage portion, 15: arithmetic portion, 16: information acquisition portion, 17: information analysis portion, 18: information visualization portion, 19: output portion, 20: chamber, 21: worker, 22: imaging device, 23: imaging device, 25: imaging device, 26: imaging device, 41: measurement data, 141: history information, 142: preliminary information, 171: classification information, 172: association information, 191: display portion, 192: work field, 193: process field, 194: feedback field, 195: visualization area, 196: head, 197: third part

1. A maintenance work analysis system to analyze work actions in maintenance work on a semiconductor manufacturing equipment, comprising:
an information acquisition portion that acquires work information including movement information indicating the movement of a worker performing the maintenance work;
an information analysis portion that analyzes work actions of the worker from the work information; and
an information visualization portion that outputs a difference between reference maintenance work and maintenance work performed by the worker.

2. The maintenance work analysis system according to claim 1,
wherein the information acquisition portion acquires result information including information regarding the success or failure of the maintenance work conducted by the worker;
wherein the information analysis portion combines the work information of the worker with the result information and analyzes a factor of the result information; and
wherein, when the result information indicates a failure, the information visualization portion outputs information regarding work and parts as a possible factor.

3. The maintenance work analysis system according to claim 1,
wherein the work information includes preliminary information that indicates history information and maintenance work concerning a process performed in the semiconductor manufacturing equipment; and
wherein the information analysis portion analyzes the work action by using the history information and the preliminary information.

4. The maintenance work analysis system according to claim 1,
the work information includes information indicating at least one of line of sight, head position/movement, finger position/movement, and work posture as the movement information,
wherein the information analysis portion analyzes the work action by using at least one piece of the motion information as an evaluation index.

5. The maintenance work analysis system according to claim 2,
wherein information concerning the success or failure of the maintenance work includes at least one of the presence or absence of leakage, amount of a particle, and process performance or yield after maintenance.

6. The maintenance work analysis system according to claim 1,
wherein the information analysis portion acquires association information that associates the movement of a worker with a work target to be maintained, and
analyzes the work action by presenting an evaluation index specific to the work target.

7. The maintenance work analysis system according to claim 6,
wherein the information analysis portion analyzes the work action by focusing on a specific work that is included in the work target and is particularly related to the success or failure of the maintenance work.

8. The maintenance work analysis system according to claim 7,
wherein the specific work is cleaning work, and
wherein the maintenance work analysis system analyzes the trajectory and speed of body parts of the worker during the cleaning work.

9. A maintenance work analysis method of analyzing work actions in maintenance work on semiconductor manufacturing equipment, comprising:
an information acquisition step to acquire work information including movement information indicating the movement of a worker conducting the maintenance work;
an information analysis step to analyze work actions of the worker from the work information; and
an information visualization step to output a difference between reference maintenance work and maintenance work conducted by the worker.
